(19) United States
(12) Patent Application Publication
(10) Pub. No.: US 2006/0031167 A1
(43) Pub. Date: Feb. 9, 2006

(54) Method for automatic charging

(75) Inventors: Georg Kastelewicz, Berlin (DE); Jens Schendel, Berlin (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 10/526,186

(22) PCT Filed: Jul. 30, 2003
(86) PCT No.: PCT/DE03/02590

§ 371 Date: Mar. 2, 2005

(30) Foreign Application Priority Data
Sep. 3, 2002 (DE) 102 41 628.1

(51) Int. Cl. G06Q 99/00

(52) U.S. Cl. 705/52; 705/51; 713/189

(57) ABSTRACT

Peer-to-peer messages supplied to a peer-to-peer message filter from a mobile radio communication network are identified and delivered to a superpeer computer which is connected to a mobile radio network-fixed network interface computer. The peer-to-peer message filter is disposed in the mobile radio communication network. At least one digital rights management service is installed in the superpeer computer.

### CLAIM FOR PRIORITY

This application is a national stage of PCT/2003/002590, published in the German language on Mar. 18, 2004 which claims priority to German Application No. 102 41 628.1 filed Sep. 3, 2002, which is incorporated herein, in its entirety, by reference.

### TECHNICAL FIELD OF THE INVENTION

The invention relates to a communication system, a peer-to-peer message filter computer and a method for processing a peer-to-peer message.

### BACKGROUND OF THE INVENTION

It is known that peer-to-peer services are provided by computers that are interconnected by means of a fixed communication network. With pure peer-to-peer services in which no index server computer is used, such as for example in the peer-to-peer architecture Gnutella, problems occur in relation to performance and scaling during the location and distribution of content to the computers interconnected via the fixed communication network.

For this reason computers known as superpeer computers (often also referred to as “search hubs”, “supernodes” or “ultrapeers”) have been used in a fixed communication network, which computers are superior to the “normal” peer-to-peer computers in terms of their performance, that is to say their computing capacity, as well as in terms of data storage with regard to the storable volume of data. The architecture with which the superpeer computers are used in the context of peer-to-peer services is also referred to as a hybrid peer-to-peer computer architecture.

Within the scope of the hybrid peer-to-peer architecture, a known practice is to use mechanisms by means of which a “normal” peer-to-peer computer is selected as a superpeer computer within a hybrid peer-to-peer service on the basis of the performance data of a peer-to-peer host computer, that is to say a computer on which a peer-to-peer service is installed. Performance data includes for example the computing capacity of the central processing unit (CPU), the available bandwidth of the communication interface or the communication link to which the peer-to-peer computer is connected, as well as the amount of storage space available in the peer-to-peer computer.

According to the prior art, the superpeer computers are only available in the fixed communication network. Communication in the fixed communication network typically takes place according to the Internet Protocol (IP) and the Transport Control Protocol (TCP) or also the User Datagram Protocol (UDP) as well as according to the peer-to-peer protocol assigned to the peer-to-peer service used in each case.

If, as part of a packet-switched communication with a mobile radio terminal device, a peer-to-peer service is to be used by said mobile radio terminal device, the performance of a peer-to-peer service used by the terminal device essentially depends on the point within the fixed communication network at which a superpeer computer associated with the respective service is disposed. With peer-to-peer service data traffic which has been generated by a mobile radio terminal device, the data packets constituting the data traffic must always be routed, for example in the case of GPRS (General Packet Radio Service), via the GGSN computer (Gateway GPRS Support Node computer) into the IP-based fixed communication network and, in the worst case, back again into a mobile radio communication network.

With this approach considerable resources are required, both in terms of the computing capacity of the computers involved as well as in terms of the available bandwidth both of the fixed communication network and of the mobile radio communication network, which in certain situations can lead to adverse effects on the rest of the data traffic or the rest of the voice traffic within the mobile radio communication network.

The basic principle of determining and disposing superpeer computers in a fixed communication network is known for example in architectures such as FastTrack or the Gnutella Reflector.

In the case of FastTrack, “normal” peer-to-peer computers are selected dynamically as an index server computer (superpeer computer) for the entire peer-to-peer communication network on the basis of their better network connection, that is to say a higher available bandwidth, compared to other peer-to-peer computers.

According to the Gnutella architecture, a so-called “reflector” computer is installed at an access point to a usually more poorly connected modem sub-communication network, which reflector computer bundles, in a manner transparent to the user, request messages from the rest of the internet-based communication network and if possible responds to them directly. The reflector computer also handles the buffering of very frequently requested data, or to put it another way “popular content”, so that peer-to-peer computers which only have a low-rate communication link are relieved of some of their load.

A reflector computer of this type is usually installed at network transition points such as, for example, at intranet/internet gateway computers.

There is also a considerable problem in the context of peer-to-peer services with regard to the usage rights of the electronic files which are identified and provided by means of the peer-to-peer services, generally with regard to Digital Rights Management (DRM) of the electronic files. Due to the decentralized structure of the peer-to-peer services, an efficient digital rights management is not possible according to the prior art.

According to the prior art, access to a peer-to-peer service is either fully granted or fully blocked.

### SUMMARY OF THE INVENTION

The invention improves the availability and efficiency of digital rights management services in the context of peer-to-peer services within a mobile radio communication network.

The invention also improves the availability of internet-based peer-to-peer services in a mobile radio communication network.

In one embodiment of the invention, there is a communication system having a fixed communication network, a mobile radio communication network and a mobile radio network-fixed network interface computer which is embodied as a connecting node between said communication networks and which is connected to the fixed communication network and the mobile radio communication network, with the mobile radio network-fixed network interface computer being set up as a GGSN computer (Gateway GPRS Support Node computer). The mobile radio network-fixed network interface computer is set up for mapping an incoming data stream from the fixed communication network onto the communication protocol used in the mobile radio communication network and for mapping an incoming data stream from the mobile radio communication network onto the communication protocol used in the fixed communication network. Also provided is a superpeer computer which is connected to the mobile radio network-fixed network interface computer. Also disposed in the mobile radio communication network is a peer-to-peer message filter which is set up in such a way that peer-to-peer messages supplied to the peer-to-peer message filter from the mobile radio communication network are identified and delivered to the superpeer computer. According to one embodiment it is provided that the communication from the fixed communication network also takes place using the peer-to-peer message filter, in which case the peer-to-peer message filter is set up in such a way that peer-to-peer messages supplied to the peer-to-peer message filter from the fixed communication network are identified and delivered to a computer in the mobile radio communication network.

Installed in the superpeer host computer there is at least one digital rights management service by means of which usage rights with regard to an electronic file which is transmitted from or to the mobile radio-fixed network interface computer are specified.

According to one embodiment of the invention, it thus becomes possible for the first time to implement a digital rights management service efficiently and reliably, with the fact being exploited according to the invention that the requested electronic files that are to be transferred into the mobile radio communication network are buffered in the superpeer host computer, with the result that a central location is created there by means of which access is enabled to the electronic files that are transmitted within the framework of a peer-to-peer service, i.e. more graphically a peer-to-peer exchange mart.

Thus, according to one embodiment of the invention, the exchanged data, i.e. the exchanged electronic peer-to-peer files, can be offered on a reliable legal basis, namely on the basis of a digital rights management system.

Thus, according to one embodiment of the invention, within the framework of a mobile radio communication network architecture, in particular when a mobile radio communication network of the third and succeeding generation is used, and through the use of a superpeer host service, the peer-to-peer data traffic is bundled and the contents of the data traffic, i.e. the exchanged electronic files that are to be transferred into the mobile radio communication network and from same, are buffered. As a result a copy of the electronic file is available in the superpeer host computer and the latter can apply the digital rights management service accordingly also present in the computer to the respective electronic file. On account of the buffered copy of the electronic file or the buffered electronic file itself the superpeer host computer can thus execute the different methods, mechanisms and any verification methods as part of the digital rights management service. Since according to the architecture of the mobile radio communication network the electronic files are usually buffered for a certain length of time in any case before they are transferred into the mobile radio communication network itself, sufficient time remains according to the invention in order to be able to execute even compute-time-intensive algorithms within the framework of the digital rights management service.

It is provided according to one embodiment of the invention to distribute the corresponding computing tasks within the framework of the digital rights management service to a plurality of computers connected to the superpeer host computer and to merge the results once again in the superpeer host computer. In this connection it is provided, for example, to combine high-performance clusters comprising a plurality of powerful computers within the scope of the calculation of the compute-intensive mechanisms of the digital rights management service.

A digital rights management service is understood to mean a service which comprises the description, identification, handling, protection, monitoring and tracking of all forms of usage rights relating to the contents of electronic files, preferably multimedia files, i.e. for example relating to text files, image files, video files, audio files, and the management of the rights relationships of the rights owners with one another. To put it another way, the digital rights management represents a set of technologies which owners of electronic content can use to protect their intellectual property rights and remain in more intimate contact with their customers. Typically, a digital rights management system is a system by means of which digital multimedia data is encrypted and access is limited to just those users who have acquired a sufficient usage license to use the contents of the multimedia file. This means that a digital rights management system has a set of technologies by means of which it is possible to distribute, promote and sell digital multimedia data via a communication network preferably based on the internet in a more secure, reliable and trusted way.

In a peer-to-peer superpeer host computer there is installed at least one digital rights management service by means of which usage rights relating to an electronic file which is transmitted from or to the mobile radio network-fixed network interface computer are specified.

With the method, an electronic file identified by the superpeer host computer in accordance with the mobile radio peer-to-peer message is processed in accordance with a digital rights management service installed in the superpeer host computer.

One advantage of the invention is to be seen in particular in the fact that the provider of the superpeer host computer, more particularly the provider of the mobile radio communication network, and the provider of the peer-to-peer service and the electronic files have the opportunity to generate additional value from a legally critical situation and at the same time provide mutual legal protection for each other.

The invention can clearly be seen in the fact that already in the mobile radio communication network or at least immediately next to or, from the viewpoint of the message flow, very close to the mobile radio communication network, internet-based peer-to-peer messages are identified and forwarded to a superpeer computer disposed very close to the mobile radio network-fixed network interface computer.

In this context the term “close” is to be understood as meaning that the superpeer computer, that is to say a computer with a superpeer functionality, is connected to the mobile radio network-fixed network interface computer by means of a communication link providing large available bandwidth, or to put it another way, by means of an optimized communication link, for example in immediate proximity to the mobile radio network-fixed network interface computer, preferably by means of direct linkage without a further switching computer being inserted in the connection, having a dedicated connection to the internet-based fixed communication network.

The peer-to-peer message filter computer and preferably also the superpeer computer are disposed in the mobile radio communication network and are administered and operated by the mobile radio communication network carrier. Alternatively, the computers can also be operated by a different carrier and do not have to be disposed in the mobile radio communication network.

The superpeer computer is preferably disposed in the mobile radio communication network, in the core network of the mobile radio communication network, for example, when a third-generation mobile radio network is used.

When a third-generation mobile radio communication protocol is used, for example according to the GPRS or the UMTS, the superpeer computer can be addressed by an SGSN computer (Serving GPRS Support Node computer) or a GGSN computer (Gateway GPRS Support Node computer).

According to one embodiment of the invention, the load due to the data traffic occurring in the core network of the mobile radio communication network on account of peer-to-peer messages frequently forwarded via a plurality of peer-to-peer computers is relieved by the early termination of peer-to-peer data traffic. The early termination is attributable in particular to the immediate proximity of the superpeer computer to the mobile radio network-fixed network interface computer.

Furthermore the support for different peer-to-peer services is optimized with regard to the required bandwidth as well as the required computing capacity of a superpeer computer.

Furthermore the response times to peer-to-peer search query messages are shortened and the requested data is available quickly to the mobile radio terminal device requesting the data, as a result of which the quality of service for a user of peer-to-peer services from a mobile communication terminal device is improved.

Furthermore the attractiveness and the additional revenue-earning opportunities for mobile radio communication network carriers are increased by the selective offering for use of own superpeer computers.

The embodiments of the invention that are described in the following relate to the communication system, the peer-to-peer superpeer host computer and the method for processing a peer-to-peer message.

The at least one digital rights management service can be set up in such a way that at least one of the following steps can be performed on the electronic file:
Insertion of a digital rights management coding scheme by means of which it is specified that after a predefined time has elapsed or at a predefined time the electronic file will become unusable for a user;
Modification of the contents of the electronic file;
Removal of a part of the electronic file;
Scanning for a computer virus, a computer worm or a Trojan horse;
Signing of the contents of the electronic file.

The signing of the contents of the electronic file serves in particular to declare the contents of the electronic file as “trusted” or “verified”.

If the operator of the superpeer host computer is, for example, the carrier of the mobile radio communication network, then the carrier takes on a position as a trusted “public person” that the carrier can, according to the invention, use to confirm the contents of the electronic files. In this case the carrier fulfills the function of what is known as a “trusted third party”. The signature of the contents of the electronic file includes for example a hash value which can be used to check whether the electronic file has or has not been modified.

In an alternative embodiment of the invention, it is provided that the contents of the electronic file can be provided with internet links (Hypertext Markup Language Links) to a provider of a desired electronic file (i.e. more precisely, to a provider address in the form of a URL (Unique Resource Locator) or with other additional data, for example with image data, for example coded according to the MPEG standard, if or as soon as predefined events have occurred, for example as soon as a predefined time interval has elapsed or when a predefined time has been reached.

It is also provided that the electronic file is downloaded directly by vendors. In this case the payment can be handled for example directly with the party offering the electronic file for sale, usually using accounting mechanisms known per user within the framework of electronic commerce, via a usage fee or via the normal accounting function of the mobile radio communication service.

According to one embodiment of the invention, the fixed communication network is based on internet protocols, that is to say in particular on the Internet Protocol (IP) and the Transport Control Protocol (TCP) or also the User Datagram Protocol (UDP).

The superpeer computer is preferably disposed in the mobile radio communication network.

By means of this embodiment of the invention, the message paths of peer-to-peer request messages that are sent by a mobile radio terminal device are shortened further and provision is made to prevent a substantial data stream from being routed into the fixed communication network and there a superpeer computer in the fixed communication network which can process the peer-to-peer request message being identified only after transmission via a plurality of switching computers and also fixed network peer-to-peer computers.

In one embodiment of the invention, it is provided that in accordance with the peer-to-peer request message additional information relating to the requested file is determined in an analogous way to a search engine, and this information is made available to the mobile radio terminal device by the superpeer computer in addition to the requested electronic file. The additional information is, for example, information about manufacturers or vendors of products which are related in a predefinable way to the requested file.

According to this embodiment of the invention, there is installed in the superpeer host computer clearly at least one search service, also referred to as a search engine, by means of which information relating to the electronic file is determined by computers provided in the fixed communication network and made available for further processing.

According to one embodiment of the invention, the mobile radio communication network is based on a mobile radio system of the third or a succeeding generation, in particular on one of the following mobile radio communication networks:
Universal Mobile Telecommunications System (UMTS),
Future Public Land Mobile Telephone System (FPLMTS).

According to another embodiment of the invention, it is provided that the mobile radio communication network is set up according to the Groupe Speciale Mobile (GSM) standard.

If a Gateway Support Node computer (GGSN computer) is provided in the mobile radio network as a mobile radio-fixed network interface computer, preferably if the mobile radio communication network is set up as a UMTS communication network, communication from the mobile radio communication network into the fixed communication network and vice versa is handled by means of the GGSN computer.

According to another embodiment of the invention, an installation mechanism is provided by means of which a peer-to-peer service is installed in the superpeer computer if the corresponding peer-to-peer service has been requested sufficiently frequently by mobile radio terminal devices.

The frequency with which a peer-to-peer service is requested by a mobile radio terminal device can be determined using a counter for a peer-to-peer service offered in each case in the superpeer computer or provided in the peer-to-peer message filter computer. If the peer-to-peer service has been requested more frequently than is provided for by a predefined threshold value, the respective peer-to-peer service is installed in the superpeer computer, also referred to below as the superpeer host computer, if said service is not already installed therein in the first place. It should be noted in this connection that a number of superpeers can be installed on the same superpeer host computer and so can run thereon.

In an alternative embodiment, it is provided to reset the respective counter of the peer-to-peer services after a predefined length of time, with the result that a request rate is used as the installation criterion for the respective peer-to-peer service, or to put it another way, a peer-to-peer service is installed in the superpeer computer if in a predefined time interval more peer-to-peer requests from the mobile radio terminal devices in the mobile radio communication network are processed by the superpeer computer than are provided for by a predefined threshold value.

### BRIEF DESCRIPTION OF THE INVENTION

An exemplary embodiment of the invention is depicted in the figure and will be explained in more detail below.

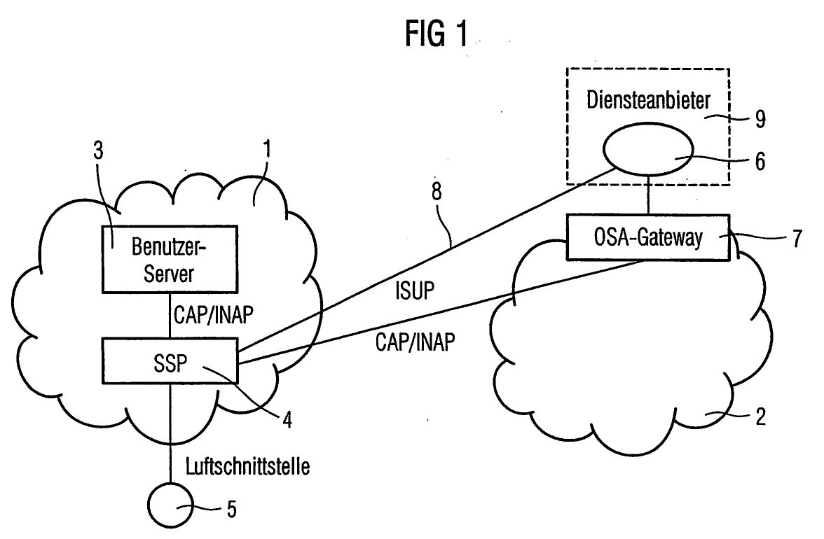

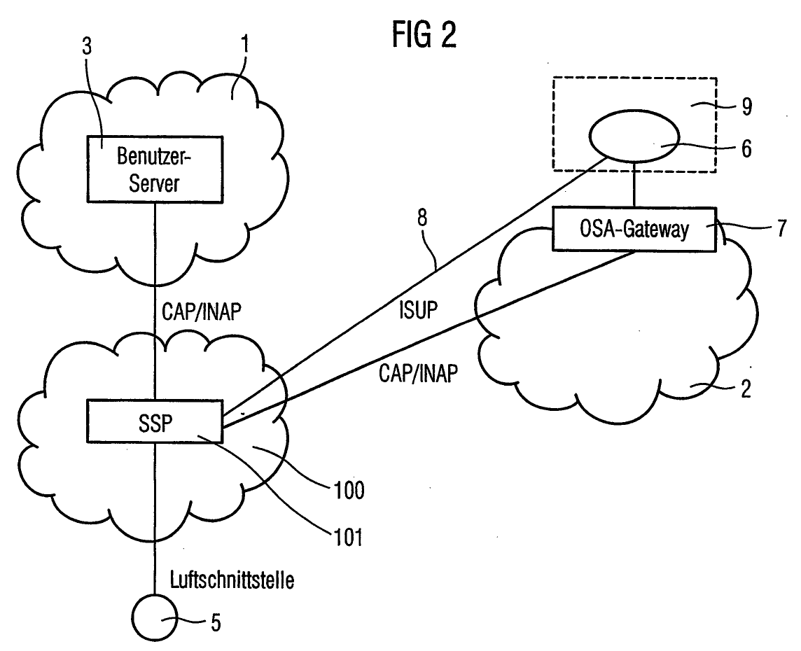

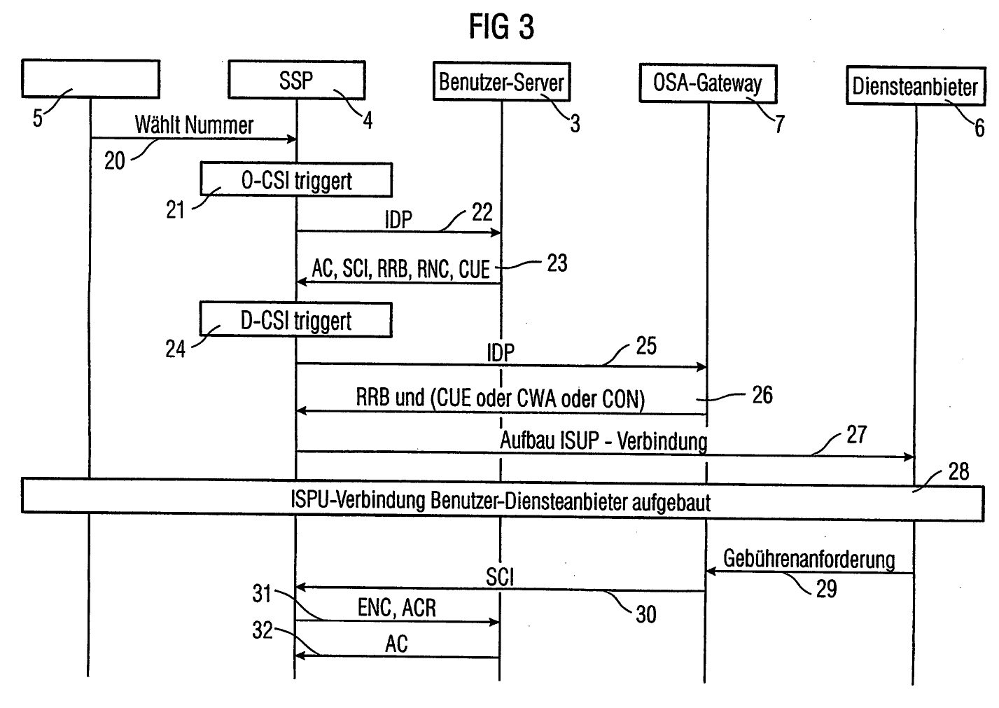

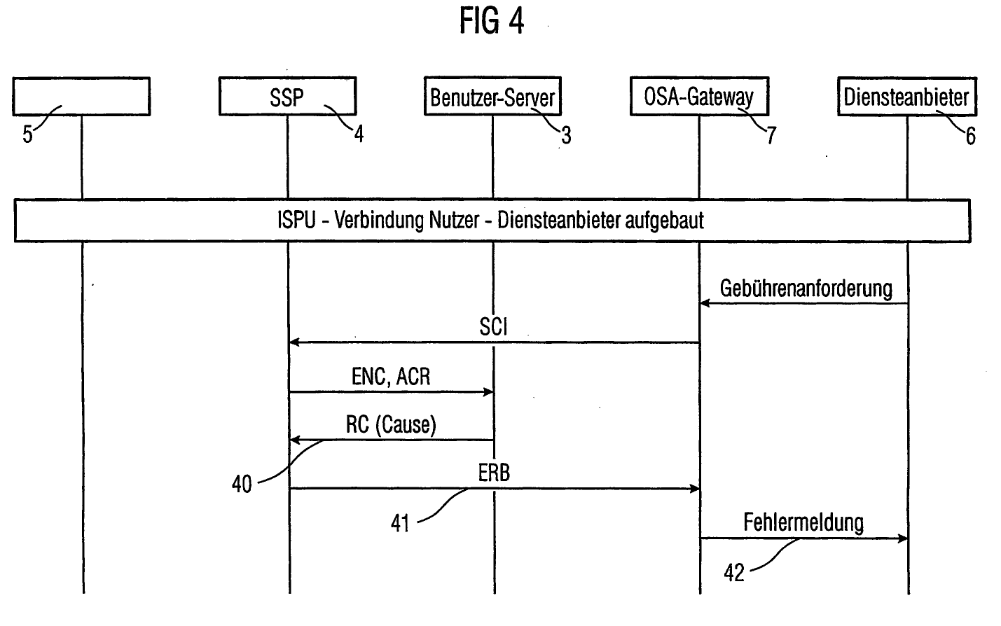

FIG. 1 shows a communication system with a fixed communication network and a mobile radio communication network.

### DETAILED DESCRIPTION OF THE INVENTION

FIG. 1 shows a communication system 100 with a fixed communication network 101 and a mobile radio communication network 102.

In the fixed communication network there are provided a plurality of computers 103, 104, 105, 106, 107, 108, 109, 110 which are connected to one another by means of the fixed communication network 101 and which, according to the present exemplary embodiment, use the Internet Protocol (IP) and the Transport Control Protocol (TCP) for communication, or to put it another way, the fixed communication network 101 is based on internet protocols.

Peer-to-peer services are also installed in a freely predefinable manner in the fixed network computers 103, 104, 105, 106, 107 and the fixed network computers 103, 104, 105 are additionally set up for communication according to the respective peer-to-peer communication protocol so that they can provide and make use of peer-to-peer services.

File sharing services, for example, are provided in the fixed network computers 103, 104, 105, or also services for providing files, for example multimedia files, in particular audio files and/or video files and/or image files, according to this exemplary embodiment audio files which include telephone ringtones. Also stored in the fixed network computers 103, 104, 105 are the multimedia files provided to other peer-to-peer computers by the respective fixed network computer 103, 104, 105.

Peer-to-peer services according to the peer-to-peer communication protocol Gnutella or the peer-to-peer communication protocol FastTrack are preferably used. If FastTrack is used as the peer-to-peer communication protocol, the peer-to-peer services Imesh, Grokster or KaZaA based thereon are provided for example.

In an alternative embodiment any peer-to-peer services and peer-to-peer communication protocols can be used.

Also provided in the fixed communication network 101 are superpeer computers 106, 107 which have superpeer functionality for some or all of the peer-to-peer services available in the network, that is to say, for example, serve as the index server for a respective peer-to-peer service.

The fixed network computers 103, 104, 105 and the fixed network superpeer computers 106, 107 form what is known as a generic peer-to-peer network 111, or to put it another way, a virtual network of computers which can communicate with one another according to the respective peer-to-peer service or the respective peer-to-peer communication protocol.

In the mobile radio communication network 102 there are provided a plurality of mobile radio terminal devices 112 which are likewise set up for providing or for making use of peer-to-peer services.

The mobile radio terminal devices 112 are connected via a radio link 113 to a base station 114 and by means of the latter to an SGSN computer 115 and via that to a GGSN computer 116, with the result that the mobile radio terminal devices 112 can exchange messages with the GGSN computer 116 according to the mobile radio protocol used in each case.

The mobile radio communication network 102 is set up according to the UMTS standard.

According to the present exemplary embodiment of the invention, the GGSN computer 116 serves as a mobile radio network-fixed network interface computer and is set up for mapping an incoming data stream from the fixed communication network 101 onto the communication protocol used in the mobile radio communication network 102 on the one hand, and on the other hand for mapping an incoming data stream from the mobile radio communication network 102 onto the communication protocol used in the fixed communication network 101 or, as the case may be, onto its data formats. Also provided in the GGSN computer 116 is a peer-to-peer message filter 117 which can identify peer-to-peer messages in the incoming message stream received in the GGSN computer 116.

This takes place, for example, such that the peer-to-peer request message 118 supplied to the GGSN computer 116 by a mobile radio terminal device 112 is supplied in the UMTS protocol format, generally in the 3GPP protocol format used in each case, and is unpacked, that is to say decoded, with the result that the peer-to-peer request message is identified in the GGSN computer 116 at the protocol level of OSI layer 7, in other words the application layer, according to the peer-to-peer communication protocol format used in each case.

Alternatively, the specification of the port via which the peer-to-peer request message 118 was received by the GGSN computer 116 can be used as an identification criterion, since a peer-to-peer service is usually assigned a unique port number.

Once the peer-to-peer request message 118 has been decoded, the GGSN computer 116 uses a mapping table in which all peer-to-peer protocol formats taken into account by the peer-to-peer message filter 117 are specified in order to determine by means of a comparison of the protocol formats whether a peer-to-peer protocol format and, if applicable, which peer-to-peer protocol format was used in the message and which peer-to-peer service was requested in the peer-to-peer request message 118.

If the GGSN computer 116 can identify the respective peer-to-peer service, it forwards the decoded peer-to-peer request message 119 to a superpeer hosting server computer 120 connected to the GGSN computer 116. The superpeer hosting server computer 120 is also disposed in the mobile radio communication network 102. The superpeer hosting server computer 120 receives the decoded peer-to-peer request message 119 and determines whether it can provide the peer-to-peer service requested in the peer-to-peer request message 119 by itself or not. According to this exemplary embodiment, a certain telephone ringtone is requested by the mobile radio terminal device 112 in the request message 119.

In the simplest case it is provided that the request message 118 is not modified in any way, but is merely unpacked, which is what happens in any case in the GGSN computer 116. This means that in this case the peer-to-peer request message 119 is a message sent by means of IP with the destination address of any adjacent peer.

In this case, the superpeer hosting server computer 120 is nothing other than a simple IP router computer, with the difference that—as mentioned above—a counting mechanism executes to ensure that, starting from a specific popularity of a service, a superpeer instance of the respective peer-to-peer service will be installed on the superpeer hosting server computer 120.

If an unmodified version of a peer-to-peer file sharing program is installed on the mobile communication terminal device, there is virtually no worthwhile means of processing these request messages efficiently in the peer-to-peer message filter 117 or the superpeer hosting server computer 120 without the peer-to-peer message filter 117 or the superpeer hosting server computer 120 already being set up in such a way that it understands a basic variant of the peer-to-peer communication protocol used, i.e. can process said protocol. In this case it should be ensured, depending on the peer-to-peer communication protocol used, that
1. a superpeer instance of the respective peer-to-peer service is installed (see above) and
2. this superpeer is notified of the IP address of the superpeer hosting server computer 120 and/or the mobile terminal devices 112. In this case the procedure followed is protocol-dependent.

Provided the superpeer selection algorithm of a specific peer-to-peer communication protocol is sufficiently intelligent, after a certain time the superpeer will automatically be found in the superpeer hosting server computer 120 and made known to the mobile users 112. From this moment the request messages 119 will be addressed to the superpeer hosting server computer 120.

To sum up, the peer-to-peer message filter 117 has to handle the following tasks:
1. Determine the popularity of a peer-to-peer service;
2. Starting from a specific popularity of a peer-to-peer service, initiate an installation of a superpeer instance of this peer-to-peer service on the superpeer host computer 120;
3. If necessary, discard messages that are not addressed to a superpeer instance in the own network, as explained in more detail below.

As described above, the peer-to-peer protocol messages are already addressed to “any” IP addresses of “known” peers of a peer-to-peer service. These known peers are identified by the peer-to-peer software either with the aid of what are termed “rendezvous” server computers which provide a list of “active” peers or on the basis of preset addresses (configuration file), or by means of a manual input by a user.

These three options also provide the starting points for integrating an own superpeer.

The parsing and manipulation of messages that are not addressed to the own superpeer is very involved and time-consuming, and worthwhile in exceptional cases.

An exceptional case of the kind is provided by what are termed “redirector” instances. These are protocol-specific and are somewhat similar to a rendezvous server computer.

They are likewise addressed directly by peer-to-peer software on the terminal device, but by means of certain messages (protocol-specific) can cause the peers to take account of superpeers.

According to the invention there thus result the following options, among others, for integrating an own superpeer:
1. Rely on the intelligence of the protocol (automatic).
2. Supply rendezvous server computer with IP of the own superpeer.
3. Provide modified versions of peer-to-peer software which already contain the address of the own superpeer.
4. Provide the address of the own superpeer on own website for manual configuration of the peer-to-peer software for downloading.
5. Make the peer-to-peer software aware of the own superpeer with the aid of redirector instances of a peer-to-peer service or by means of peer-to-peer protocol messages which permit a redirect.
6. The filter discards all messages not addressed to the superpeer. However, this only works when linked with an above-mentioned method for making the own superpeer known to the terminal devices.

If the corresponding peer-to-peer service is installed in the superpeer hosting server computer 120, it provides the requested peer-to-peer service and communicates the result of the requested peer-to-peer service to the GGSN computer 112 in a peer-to-peer response message 121. The peer-to-peer response message 121 is transmitted to the mobile radio terminal device 112 sending the peer-to-peer request message 119. The multimedia file specified in the peer-to-peer request message 119, including, according to the present exemplary embodiment, the desired telephone ringtone, can then be read out from the memory of the peer superpeer hosting server computer 120 and sent to the mobile radio terminal device 112 or also loaded by the respective peer-to-peer server.

In this case, it is assumed as a prerequisite that an already installed and established superpeer supports a so-called “caching” function and that the desired telephone ringtone has already been requested once and is therefore cached, i.e. buffered, on the superpeer. The data transmission can therefore take place. A distinction is made in each case between request/response messages and the actual data exchange. If the data is not cached, the superpeer hosting server computer 120 only specifies the information relating to where in the peer-to-peer network the data is to be found. The downloading then takes place from there.

In the above case, this avoids a data stream reaching the fixed communication network 101 at all and tying up resources in that network.

A digital rights management system comprising a plurality of provided digital rights management services 122 is also installed in the superpeer hosting server computer 120.

According to this exemplary embodiment of the invention, any mechanisms for providing different digital rights management services may be installed.

In particular the following digital rights management services are installed in the superpeer hosting server computer 120:
a service for inserting a digital rights management coding scheme by means of which it is specified that after a predefined time has elapsed or at a predefined time an electronic file specified in each case will become unusable or will be deleted;
a service for modifying the contents of a specified electronic file;
a service for removing part of the contents of a specified electronic file;
a service for scanning the electronic file for a computer virus, a computer worm or a Trojan horse;
a service for signing the contents of a specified electronic file.

Thus, when the requested electronic file is loaded onto the superpeer hosting server computer 120, the electronic file is cached, i.e. buffered, and the above described digital rights management services are performed on the buffered electronic file before the latter is transmitted to the mobile radio terminal device 112.

In this way the mobile radio terminal device 112 is provided with the requested peer-to-peer service.

It should be pointed out in this connection that according to an alternative embodiment, the above described procedure is also provided in the other communication direction, namely in a request message sent from the fixed communication network into the mobile radio communication network.

However, if the requested peer-to-peer service is not installed in the superpeer hosting server computer 120, the superpeer hosting server computer 120 forwards the request message 119 into the fixed communication network 101 (not shown), that is to say into the internet or into the peer-to-peer network 111 to the further fixed network superpeer computers 106, 107 or to the other fixed network peer-to-peer computers 103, 104, 105 and in this way requests the peer-to-peer service for the mobile radio terminal device 109 from the fixed network computers 103, 104, 105, 106, 107. In this case the superpeer hosting server computer 120 clearly represents an additional IP router computer.

Also provided in the superpeer hosting server computer 120 for any peer-to-peer service known to it at all is a counter which, upon reception of a peer-to-peer request for the respective peer-to-peer service, is incremented by the value 1 if the respective peer-to-peer service has previously not been installed on the superpeer hosting server computer 120.

If the counter value exceeds a predefined threshold value, the peer-to-peer service thus achieving a sufficient popularity is installed and configured on the superpeer hosting server computer 120 manually, preferably automatically, by means of an installation mechanism.

At the time of installation of the respective peer-to-peer service on the superpeer hosting server computer 120, the service to be installed is configured and equipped with resources, for example with sufficient computing capacity, a sufficiently fast communication link, i.e. a link provided with a sufficiently large bandwidth, into the fixed communication network, and with sufficient memory or storage space, in such a way that the instance of the respective peer-to-peer service within the entire peer-to-peer network is promoted to a superpeer computer.

In this connection, during installation of the peer-to-peer service on the superpeer hosting server computer 120 the service is published on correspondingly provided World Wide Web pages of a peer-to-peer service or an entry is made on so-called “rendezvous” server computers or in host caches.

The mobile radio terminal devices 112 that wish to use a specific peer-to-peer service can also be informed, preferably also automatically, of the presence of a superpeer instance for the respective peer-to-peer service in the provider-own mobile radio communication network and configured accordingly.

The invention can be seen clearly in the fact that a superpeer computer is connected as far as possible in an optimized manner to a mobile radio communication network or is already disposed in the mobile radio communication network 102 itself and is operated by the mobile radio network provider, so that peer-to-peer request messages sent by a mobile radio terminal device 109 are not transmitted into the entire, above fixed network-based, peer-to-peer network 111, but the messages are terminated at the earliest possible time, as a result of which the data traffic occurring is reduced.

It should be pointed out in this connection that the invention can be applied both to peer-to-peer architectures having two hierarchy levels and also to hybrid peer-to-peer architectures provided with any number of additional hierarchy levels.

In an alternative embodiment of the invention it is provided that in a search query for an electronic file according to the respective peer-to-peer service an inquiry in respect of the electronic file is made to a rights provider, more precisely to a digital rights provider computer, that is connected to the superpeer hosting server computer, to ascertain which rights information is assigned to the respective requested electronic file.

The digital rights provider computer is set up such that it has stored information relating to a plurality of electronic files and/or file providers, the information detailing which digital rights exist with regard to the use of the respective requested electronic file.

The digital rights data is transmitted in response to a request from the superpeer hosting server computer 120 to the latter by the digital rights provider computer. The superpeer hosting server computer 120 processes the requested electronic file according to the rights information transmitted to it.

1. A communication system, comprising:
a fixed communication network;
a mobile radio communication network;
a mobile radio network-fixed network interface computer which is connected to the fixed communication network and to the mobile radio communication network for mapping a data stream between the fixed communication network and the mobile radio communication network;
a superpeer host computer which is connected to the mobile radio network-fixed network interface computer; and
a peer-to-peer message filter which is disposed in the mobile radio communication network and which is set up such that peer-to-peer messages supplied to the peer-to-peer message filter from the mobile radio communication network are identified and can be delivered to the superpeer host computers,
wherein at least one digital rights management service is installed in the superpeer host computer, by means of which digital rights management service usage rights with regard to an electronic file which is transmitted from or to the mobile radio network-fixed network interface computer are specified.

2. The communication system according to claim 1, wherein the at least one digital rights management service is set up such that at least one of the following is performed on the electronic file:
inserting a digital rights management coding scheme by means of which it is specified that the electronic file will become unusable after a predefined time has elapsed or at a predefined time;
modifying the contents of the electronic file;
removing part of the electronic file;
scanning for a computer virus, a worm or a Trojan horse; and
signing the contents of the electronic file.

3. The communication system according to claim 1, further comprising a digital rights provider computer which is connected to the superpeer host computer and is set up such that it transmits to the superpeer host computer the rights to be taken into account for the electronic file in each case.

4. The communication system according to claim 1,
wherein the fixed communication network is based on internet protocols.

5. The communication system according to claim 1,
wherein the superpeer host computer is disposed in the mobile radio communication network.

6. The communication system according to claim 1,
wherein the mobile radio communication network is based on a mobile radio system of the third or a succeeding generation.

7. The communication system according to claim 6, wherein the mobile radio communication network is based on one of the following mobile radio communication networks:
Universal Mobile Telecommunications System, and
Future Public Land Mobile Telephone System.

8. The communication system according to claim 1,
wherein the mobile radio communication network is based on a mobile radio communication network according to Groupe Speciale Mobile.

9. The communication system according to claim 6, wherein the mobile radio communication network is based on the Universal Mobile Telecommunications System, and
the mobile radio network-fixed network interface computer is a Gateway GPRS Support Node computer.

10. The communication system according to claim 1, further comprising an installation mechanism which is set up such that a peer-to-peer service is installed in the superpeer computer if the service is requested sufficiently frequently.

11. The communication system according to claim 1,
wherein the superpeer host computer has installed at least one search service by means of which information relating to the electronic file is determined by the computers provided in the fixed communication network and made available for further processing.

12. The communication system according to claim 1, where a peer-to-peer superpeer host computer has installed at least one digital rights management service by means of which usage rights with regard to an electronic file which is transmitted from or to the mobile radio network-fixed network interface computer are specified.

13. A method for processing a peer-to-peer message, comprising:
identifying a mobile radio peer-to-peer message by a peer-to-peer message filter computer disposed in a mobile radio communication network;
transmitting the mobile radio peer-to-peer message to a superpeer computer connected to a mobile radio network-fixed network interface computer
processing the mobile radio peer-to-peer message by the superpeer host computer; and
processing an electronic file identified by the superpeer host computer according to the mobile radio peer-to-peer message according to a digital rights management service installed in the superpeer host computer.
